(19) United States
(12) Patent Application Publication
(10) Pub. No.: US 2016/0073666 A1
(43) Pub. Date: Mar. 17, 2016

(54) Supplement for a Breastfeeding Woman

(71) Applicant: New Chapter, Inc., Cincinnati, OH (US)

(72) Inventors: Taryn Louise Forrelli, North Andover, MA (US); Graham Robert Michael Rigby, Keene, NH (US); Paul Schulick, Brattleboro, VT (US)

(21) Appl. No.: 14/487,586

(22) Filed: Sep. 16, 2014

(51) Int. Cl. A23L 1/29; A23L 1/304; A23L 1/30; A23L 1/303

(52) U.S. Cl. CPC A23L 1/296; A23L 1/303; A23L 1/304; A23L 1/3002; A23V 2002/00

(57) ABSTRACT

A daily intake formulated for breastfeeding women containing iron, vitamin B6, iodine, vitamin D, and herbs and galactogogues that support milk production.

### FIELD OF THE INVENTION

This invention relates to a supplement for a breastfeeding woman, particularly a supplement that supports the enhanced nutritional needs of breastfeeding women.

### BACKGROUND OF THE INVENTION

Breastfeeding can provide health and emotional benefits for infants and their mothers. In fact, in 2012, the American Association of Pediatrics recommended exclusive breastfeeding for six months, with continuation up to one year or longer.

The nutrition requirements for lactating women are unique. The Recommended Dietary Allowances (RDA) for lactating women are higher than for pregnant and adult women. For successful lactation, both infants and their mothers need to be well nourished. Maternal nutrient deficiencies, including micronutrient deficiencies, can cause a major reduction in concentration of nutrients in breast milk. Furthermore, during lactation the mammary gland exhibits metabolic priority for nutrients, particularly micronutrients, often at the expense of maternal reserves, which can make a breastfeeding mother fatigued, irritable, and stressed.

According to the Center for Disease Control (CDC), approximately 77% of women initiate breastfeeding. However, this rate decreases to 49% at six months and 27% at twelve months. There are many factors that can contribute to early cessation of breastfeeding. Many women find breastfeeding demanding, tiring, and uncomfortable and many women have concerns about their milk production. In fact, insufficient milk production or oligogalactia, is the most commonly cited reason why women wean early.

Thus, there is a need for supplementation that supports the enhanced nutritional needs of women who are breastfeeding and can provide energy, mood, and lactation support for new moms.

### SUMMARY OF THE INVENTION

A daily intake formulated for breastfeeding women comprising: (a) less than about 18 mg per daily intake iron; (b) greater than about 2 mg per daily intake vitamin B6; (c) iodine; (d) greater than about 600 IU per daily intake vitamin D; and (e) herbs and galactogogues wherein the herbs and galactogogues support milk production.

A daily intake formulated for breastfeeding women comprising: (a) less than about 18 mg per daily intake iron; (b) greater than about 2 mg per daily intake vitamin B6; (c) iodine wherein at least a portion of the iodine is from kelp; (d) greater than about 600 IU per daily intake vitamin D3; (e) a first herbs and galactogogues selected from the group consisting of oat, lemon balm leaf, chamomile flower, lavender flower, cardamom seed, and combinations thereof and wherein the first herbs and galactogogues are fermented; (f) a second herbs and galactogogues selected from the group consisting of kelp, amla, cumin seed, turmeric, and combinations thereof; (g) from about 60 mg to about 120 mg vitamin C; (h) from about 50 mg to about 150 mg calcium; (i) greater than about 10 mg magnesium; (j) from about 1 to about 3 mg manganese; wherein the daily intake supports the overall health and well-being of a breastfeeding woman.

A method of supporting the overall health and well-being of a breastfeeding woman by administering a daily intake comprising: (a) less than about 18 mg per daily intake iron; (b) greater than about 2 mg per daily intake vitamin B6; (c) iodine wherein at least a portion of the iodine is from kelp; (d) greater than about 600 IU per daily intake vitamin D3; and (e) herbs and galactogogues wherein the herbs and galactogogues support milk production; wherein the composition is gentle enough that it can be administered on an empty stomach; and wherein the daily intake comprises one or more tablets.

### DETAILED DESCRIPTION OF THE INVENTION

Mothers generally want to give their infants the best health and nutrition possible, which frequently includes breastfeeding. However, this can be difficult since lactating women have special nutrition requirements and the RDAs for lactating women are higher than pregnant and adult women. Thus, mothers have to carefully monitor their nutrients, in particular micronutrients, as maternal micronutrient deficiencies during lactation can cause a major reduction in concentration of nutrients in breast milk and can impact the health and well-being of the mother.

Furthermore, postpartum women often feel fatigued, irritable, and stressed, all of which can lead to difficulties producing milk. Still other women produce too much milk, which can be uncomfortable for the mother and can make feedings stressful for both the mother and infant.

New and nursing moms may desire a unique supplement that is specifically formulated for their needs and can help provide healthy breast milk and support postpartum. The supplement can nourish a woman's body after pregnancy and birth supporting her healthy mood, digestion, energy, lactation, and unique nutritional needs. In one example the supplement can provide holistic support for breastfeeding moms and in another example, the supplement can be organic.

The supplement can include whole-food cultured vitamins and minerals, including but not limited to whole-food iron, vitamin B6, iodine, and vitamin D3 and a unique blend of herbs. The supplement can help a postpartum woman feel calm and balanced (e.g. balanced milk production, balanced energy levels so she has the energy to take care of her baby but can still get a good night's sleep).

In one example, the supplement can be rich in vitamin D3 and can provide about 2000 international units (IU) of vitamin D3. In another example the supplement can provide about 1000 IU of vitamin D3. Babies and breastfeeding moms can require vitamin D supplementation because breast milk is not naturally rich in vitamin D and they generally do not spend significant amounts of time in the sun, which would allow their skin to synthesize vitamin D.

In another example, the supplement can provide thyroid support and can include 150 μg of iodine, as iodine needs increase during lactation. The iodine can be naturally harvested from organic kelp, which can deliver iodine naturally from the sea, and/or can be whole-food cultured iodine.

In another example, the supplement can provide postpartum body nourishment to help address the physiologic needs of the body after pregnancy. This can include whole-food cultured iron, which can be required for red blood cell production.

The supplements can also include a complimentary blend of botanicals including organic oat, black cumin, lemon balm, seaweed (kelp), turmeric, cardamom and chamomile. The botanicals can have a galactagogue effect and can also be used to support healthy mood and stress response and promote digestive health in breastfeeding women.

As used herein, the terms “administer,” “administering,” and “administration,” refer to any method which, in sound medical practice, delivers the composition to a subject in such a manner as to provide a therapeutic effect.

As used herein, the term “supercritical extraction” refers to the technique in which hydrophobic compounds can be extracted from samples utilizing a supercritical fluid. The solvation power of a supercritical fluid is increased as the pressure and temperature are increased above their critical points, producing an effective solvent for the isolation of hydrophobic molecules.

As used herein, the term “supplement” refers to a composition intended to supplement a diet of food and water, where the diet is sufficient to support life. A supplement may contain vitamins, minerals, herbs or other botanicals, amino acids, enzymes, organ tissues, glandular metabolites, or combinations thereof. A supplement may be an extract or concentrate of a particular food source or a particular nutrient. Supplements may be administered by any convenient means, including parenteral or enteral routes. Enteral routes may include oral, gastric, or subgastric administration, including rectal administration.

In a preferred form, the supplements of the present invention are administered orally. Oral administration forms include, without limitation, tablets, capsules, softgels, gelcaps, liquids, powders, and films, as well as food-like forms such as bars, candies, lozenges, beverages, and the like. In one example, the supplement can be a tablet.

As used herein, the articles “a” and “an” are understood to mean one or more of the material that is claimed or described, for example, “an active ingredient” or “a supplement”.

The supplement can contain, consist of, or consist essentially of, the essential elements and limitations of the invention described herein, as well as any additional or optional ingredients, components, or limitations described herein or otherwise useful in supplements intended for use or consumption by humans.

The supplement can provide nourishment and healthy and nutritious breast milk and can be formulated with a unique blend of vitamins, minerals, and botanicals specifically designed for breastfeeding women. The supplement can include whole-food cultured vitamins and minerals, including but not limited to whole-food iron, vitamin B6, iodine, and vitamin D3.

The supplement can be taken three times a day, for instance, morning, noon, and night. In one example, the supplement can be gentle enough that it does not have to be administered with a meal and/or can be administered on an empty stomach.

The supplement can contain one or more active ingredients. The active ingredients can include vitamins, and minerals. Non-limiting examples of active ingredients can include vitamin C, vitamin D, vitamin E, vitamin K1, Vitamin K3, vitamin B1, vitamin B2, vitamin B3, vitamin B6, folic acid, vitamin B12, vitamin B3, vitamin B7, pantothenic acid, calcium, magnesium, iron, iodide, zinc, selenium, copper, manganese, chromium, molybdenum, beta-carotene, and combinations thereof. The active ingredients can be at levels above, below, and/or equal to the RDA, depending on the particular active ingredient.

The actives ingredients and some of the herbs can be whole-food cultured and can be cultured in organic media that can contain probiotics and other nutrients. In one example, the media can contain organic milled soy, Saccharomyces cerevisiae (organic yeast: active and inactive), organic maltodextrin, organic gum acacia, organic orange peel, organic lemon peel, organic carrot powder, organic alfalfa powder, Lactobacilli (L. acidophilus, L. bifidus, L. rhamnosus) and enzymes (deactivated).

In another example, the active ingredient can be vitamin D. The RDA for lactating women is 600 IU per day of vitamin D. However, intake at this level in the absence of sun exposure will likely result in insufficient amounts, as new mothers are highly encouraged to remain indoors with newborns. Vitamin D is essential for calcium absorption and utilization and also plays a role in bone metabolism, immunity, insulin function, blood pressure regulation, and cell differentiation. Thus, the supplement can contain about 2000 IU of vitamin D per daily intake. In another example the supplement can contain about 1000 IU of vitamin D. The supplement can be rich in vitamin D. In one example, the vitamin D can be Vitamin D3. In one example the supplement contains greater than about 600 IU per daily intake vitamin D, in another example greater than about 1000 IU per daily intake, in another example greater than about 1500 IU per daily intake, and in another example greater than about 1750 IU per daily intake. In another example the supplement can contain from about 500 to about 3000 IU per daily intake, in another example from about 1000 to about 2500 IU per daily intake, and in another example from about 1500 to about 2250 IU per daily intake. In another example the supplement can contain from about 250 to about 1500 IU per daily intake, in another example from about 500 to about 1750 IU per daily intake, and in another example from about 750 to about 1250 IU per daily intake.

In another example, the active ingredient can be iodine. Iodine is an integral component of thyroid hormones T3 and T4 and is thus imperative to the mediation of thyroid hormone effects in the body, which impact the metabolism at almost every tissue. The need for iodine in lactating women is particularly important, not only for the baby's thyroid needs, but to support the continued needs of the mother as iodine from the mother is preferentially concentrated in breast milk even when a mother may have low iodine levels to meet her own needs. The supplement can provide thyroid support and can contain 150 μg per daily intake iodine. This can include 75 μg of iodine from kelp, in particular organic kelp, which is a natural source of iodine.

In one example, the supplement can contain iodine from both whole-food cultured iodine and kelp. In one example the ratio of iodine from whole-food per daily intake to iodine from kelp per daily intake is from about 1:4 to about 4:1, in another example from about 1:3 to about 3:1, and in another example from about 1:2 to about 2:1. In one example, about half of the iodine can come from whole-food cultured iodine and about half the iodine can come from kelp. In another example, about 100% of the iodine can come from whole-food cultured iodine and in another example about 100% of the iodine can come from kelp. In one example, the kelp can be Ascophyllum nodosum, a brown alga that is found in the northern Atlantic Ocean. The kelp can be organic and harvested in an ecologically sustainable manner.

In one example the total iodine is less than about 290 μg per daily intake, in another example less than about 200 μg per daily intake, and in another example less than 175 μg per daily intake. In another example, the total iodine is greater than about 75 μg per daily intake, in another example greater than about 90 μg per daily intake, and in another example greater than about 120 μg per daily intake. In another example, the total iodine is from about 40 μg to about 300 μg, in another example from about 75 μg to about 250 μg, and in another example from about 100 μg to 200 μg.

In another example, the active ingredient can be iron. Iron is essential for the production of hemoglobin, the primary protein found in red blood cells that function to transport oxygen. The supplement can contain iron to help address the physiologic needs of the body after pregnancy. Whole-food cultured iron, as well as folic acid, can be required for red blood cell production. The supplement can provide postpartum body nourishment. The supplement can deliver an iron level formulated to meet the specific needs of the postpartum woman and breastfed infant. The postpartum period can require less iron than in pregnancy and can also require less iron than adult women who are menstruating. Low iron stores and iron deficiency anemia can often go unnoticed and undiagnosed, especially in the postpartum period, as common symptoms such as fatigue, irritability, and difficulties concentrating are often passed off as common symptoms of this specific population. However, too much iron can be accumulated in the body and can cause toxicity.

In one example, the supplement can contain less than about 18 mg iron per daily intake, in another example less than about 15 mg per daily intake, in another example less than about 10 mg per daily intake. In another example, the supplement can contain from about 3 mg to about 20 mg iron, in another example from about 5 mg to about 15 mg, and in another example from about 8 mg to about 12 mg.

In another example, the active ingredient can include one or more B vitamins. Non-limiting examples of B vitamins can include vitamin B1 (thiamin), vitamin B2 (riboflavin), vitamin B3 (niacin or niacinamide), vitamin B5 (pantothenic acid), vitamin B6 (pyridoxine), vitamin B7 (biotin), vitamin B9 (folic acid), vitamin B12, and combinations thereof. The B vitamins can support the energy and mood of a lactating woman. The supplement can provide energy to the lactating woman, while also providing a soothing benefit to help relax her. The B vitamins can help provide nutritious breast milk.

In another example, the active ingredient can be vitamin B 1. In one example, the supplement can contain greater than 1.4 mg vitamin B1 per daily intake, in another example greater than 2 mg, and in another example greater than 3 mg. In another example, the supplement can contain from about 1 mg to about 10 mg vitamin B1 per daily intake, in another example from about 2 mg to about 7 mg per daily intake, and in another example from about 3 mg to about 5 mg per daily intake.

In another example, the active ingredient can be vitamin B2. In one example, the supplement can contain greater than about 1.6 mg vitamin B2 per daily intake, in another example greater than 3 mg per daily intake, and in another example greater than 4 mg per daily intake. In one example the supplement can contain about 1 mg to about 10 mg vitamin B2 per daily intake, in another example from about 3 mg to about 8 mg per daily intake, and in another example from about 4 mg to about 6 mg per daily intake.

In another example, the active ingredient can be vitamin B3. In one example the supplement can contain about 5 mg to about 35 mg vitamin B3 per daily intake, in another example from about 10 mg to about 28 mg per daily intake, and in another example from about 15 mg to about 25 mg per daily intake.

In another example, the active ingredient can contain vitamin B5. In one example, the supplement can contain about 1 mg to about 20 mg vitamin B5 per daily intake, in another example from about 5 mg to about 15 mg per daily intake, and in another example from about 8 mg to about 12 mg per daily intake.

In another example, the active ingredient can be vitamin B6. In one example, the supplement can contain greater than about 2 mg per daily intake vitamin B6, in another example greater than about 5 mg per daily intake, and in another example greater than 8 mg per daily intake. In another example, the supplement can contain from about 3 mg to about 20 mg vitamin B6 per daily intake, in another example from about 6 mg to about 15 mg per daily intake, and in another example from about 8 mg to about 12 mg per daily intake.

In another example, the active ingredient can contain vitamin B7. In another example, the supplement can contain from about 100 μg to about 600 μg vitamin B7, in another example from about 175 μg to about 450 μg, and in another example from about 250 μg to about 350 μg.

In another example, the active ingredient can contain vitamin B9. In one example, the supplement can contain less than about 600 μg per daily intake of vitamin B9, in another example less than about 500 μg, and in another example less than about 450 μg. In another example, the supplement can contain from about 100 μg to about 750 μg vitamin B9, in another example from about 250 μg to about 600 μg, and in another example from about 350 μg to about 450 μg.

In another example, the active ingredient can be vitamin C. The vitamin C can be from whole-food cultured vitamin C and/or from alma extract. In one example, the supplement can contain from about 40 mg to about 150 mg vitamin C, in another example from about 60 mg to about 120 mg, and in another example from about 85 mg to about 110 mg. In one example, the supplement can contain greater than about 60 mg vitamin C, in another example greater than about 75 mg, and in another example greater than about 80 mg. In one example, the supplement can contain less than about 120 mg vitamin C, in another example less than about 110 mg, and in another example less than about 100 mg.

In one example, the supplement can contain vitamin C from both whole-food cultured vitamin C and alma. In one example the ratio of vitamin C from whole-food per daily intake to vitamin C from alma extract per daily intake is from about 1:4 to about 4:1, in another example from about 1:3 to about 3:1, and in another example from about 1:2 to about 2:1. In one example, about half of the vitamin C can come from whole-food cultured vitamin C and about half the vitamin C can come from alma extract. In another example, about 100% of the vitamin C can come from whole-food cultured vitamin C and in another example about 100% of the vitamin C can come from alma extract.

In one example, the supplement can contain calcium. In one example, the calcium can be from Lithothamnion calcareum. In another example, the calcium can be whole-food cultured calcium. In one example the supplement can contain less than about 1000 mg calcium per daily intake, in another example less than about 200 mg per daily intake, and in another example less than about 100 mg per daily intake. In another example the supplement can contain about 25 to about 200 mg per daily intake, in another example from about 50 mg to about 150 mg per daily intake, and in another example from about 60 mg to about 90 mg.

In one example the supplement can contain from about 75 mg to about 750 mg Lithothamnion calcareum, in another example from about 150 to about 450 mg, in another example from about 100 to about 400 mg, and in another and in another example from about 200 to about 300 mg.

In another example, the supplement can contain vitamin E. In one example the supplement can contain greater than about 28.5 IU vitamin E per daily intake and in another example greater than about 30 IU per daily intake. In another example the supplement can contain from about 10 to about 60 IU vitamin E per daily intake, in another example from about 20 to about 45 IU per daily intake, and in another example from about 30 to about 40 IU per daily intake.

In another example, the supplement can contain K vitamins which can include vitamin K1 and/or vitamin K2. In one example, the supplement can contain less than about 90 μg of K vitamins. In one example the supplement can contain from about 20 to about 160 μg per daily intake of K vitamins, in another example from about 40 to about 130 μg per daily intake, and in another example from about 60 to about 100 μg per daily intake.

In one example, the supplement can contain both vitamin K1 and vitamin K2. In one example, the supplement can contain more vitamin K1 than vitamin K2. In another example, the ratio of the amount of vitamin K1 per daily intake to vitamin K2 per daily intake can be from about 1:1 to about 15:1, in another example from about 3:1 to about 10:1, and in another example from about 6:1 to about 8:1. In one example the supplement can contain from about 30 to about 110 μg K1 per daily intake, in another example from about 50 to about 90 μg per daily intake, and in another example from about 60 to about 80 μg per daily intake. In another example the supplement can contain from about 2 to about 20 μg per daily intake vitamin K2, in another example from about 5 to about 15 μg per daily intake, and in another example from about 8 to about 12 μg per daily intake.

In another example, the supplement can contain magnesium. In one example at least a portion of the magnesium can come from Lithothamnion calcareum. In one example the supplement can contain greater than about 10 mg magnesium per daily intake and in another example greater than about 15 mg magnesium per daily intake. In another example the supplement can contain less than about 300 mg magnesium per daily intake, in another example less than about 200 mg per daily intake, and in another example less than about 100 mg per daily intake. In another example the supplement can contain from about 5 to about 40 mg magnesium per daily intake, in another example from about 10 to about 30 mg per daily intake, in another example from about 15 mg to about 25 mg per daily intake, and in another example from about 18 mg to about 23 mg per daily intake.

In another example, the supplement can contain zinc. In one example the supplement can contain greater than about 7.5 mg zinc per daily intake and in another example the supplement can contain greater than about 9 mg zinc per daily intake. In one example the supplement can contain from about 1 to about 20 mg zinc per daily intake, in another example from about 5 to about 15 mg per daily intake, and in another example from about 8 to about 12 mg per daily intake.

In another example, the supplement can contain selenium. In one example the composition can contain greater than about 50 μg selenium per daily intake and in another example the composition can contain less than about 100 μg selenium per daily intake. In one example, the composition can contain from about 40 to about 120 μg selenium per daily intake, in another example from about 50 μg to about 100 μg per daily intake, and in another example from about 60 to about 80 μg per daily intake.

In another example, the supplement can contain copper. In one example the supplement can contain greater than about 500 μg per daily intake copper and in another example the supplement can contain greater than about 750 μg per daily intake. In one example the supplement can contain from about 500 μg to about 2 mg copper per daily intake, in another example from about 800 μg to about 1.5 mg per daily intake, and in another example from about 900 μg to about 1.25 mg per daily intake.

In another example, the supplement can contain manganese. In one example the supplement can contain from about 0.5 to about 5 mg per daily intake manganese, in another example from about 1 to about 3 mg per daily intake, and in another example from about 1.5 to about 2.5 mg per daily intake.

In another example, the supplement can contain chromium. In one example the supplement can contain from about 25 to about 200 μg chromium per daily intake, in another example from about 50 to about 150 μg per daily intake, and in another example from about 75 to about 125 μg per daily intake.

In another example, the supplement can contain molybdenum. In one example the supplement can contain greater than about 10 μg molybdenum per daily intake and in another example less than about 150 μg per daily intake. In one example the supplement can contain from about 5 to about 35 μg molybdenum per daily intake, in another example from about 10 to about 30 μg per daily intake, and in another example from about 15 to about 20 μg per daily intake.

In another example, the supplement can contain vitamin A. In one example, 100% of the vitamin A can be beta-carotene. In one example the supplement can contain from about 100 to about 10,000 IU beta-carotene per daily intake, in another example from about 1000 to about 8000 IU per daily intake, in another example from about 3000 to about 7000 IU per daily intake, and in another example from about 4000 to about 6000 IU per daily intake.

The supplement can contain a unique blend of herbs and galactogogues that were selected to support milk production and provide a calming effect to the mother. When a woman is relaxed, her oxytocin levels can go up, and she can produce more milk. Furthermore, the herbs and galactogogues can support adequate mineral intake for mothers to make good quality milk. The herbs and galactogogues can also help a user maintain a healthy digestive system. In some examples, the herbs and galactogogues can be turmeric, which can prevent inflammation. In another example, the galactagogue or herb can be an antioxidant.

Non-limiting examples of herbs and galactogogues can include almonds, anise, asparagus, borage, black cumin, caraway, chamomile, chaste tree fruit, chicken soup, cilantro, coconut, coriander, cumin, dandelion, dill, fennel, fenugreek, garlic, ginger, hops, lettuce, lemon balm, marshmallow root, millet, mushrooms, nettle, oat (both the seed and the straw), papaya, pumpkin, red clover, red raspberry, rice, sage, seaweed, sesame seeds, sunflower seeds, thistles, turmeric, vervain, and combinations thereof.

In another example, the supplement can be administered in combination with an herb or galactagogue. For instance, the supplement can be administered in combination with tea, such a tea containing lemon balm and/or chamomile.

In one example, all of the herbs and galactogogues in the supplement can be organic. In another example, a portion of the herbs and galactogogues in the supplement can be organic.

In one example, the herbs and galactogogues can be full-spectrum herbs, where the herbs can contain the natural profile of fat-soluble and water-soluble compounds naturally present in the plant or food.

In one example, the herbs and galactogogues can be a blend of fermented herbs, which can increase the digestibility and activity of the herbal constituents. Non-limiting examples of fermented herbs can include oat, lemon balm leaf, chamomile flower, lavender flower, cardamom seed, and combinations thereof. In one example, the supplement can contain from about 50 to about 500 mg per daily intake of fermented herbs, in another example from about 100 to about 425 mg per daily intake, in another example from about 200 to about 375 mg per daily intake, and in another example from about 275 to about 350 mg/daily intake.

In one example, the herb and galactogogue can be kelp and the kelp can be a powder. The kelp can provide a source of iodine. In one example the supplement can contain from about 50 to about 250 mg/daily intake kelp, in another example from about 75 to about 200 mg/daily intake, and in another example from about 100 to about 150 mg/daily intake.

In another example the herb and galactagogue can be alma extract. The alma extract can be aqueous. In one example the supplement can contain from about 25 to about 200 mg/daily intake alma extract, in another example from about 50 to about 150 mg/daily intake, and in another example from about 75 to about 125 mg/daily intake.

In another example the herb and galactagogue can be black cumin seed. In one example the supplement can contain from about 10 to about 100 mg/daily intake black cumin seed, in another example from about 20 to about 80 mg/daily intake, and in another example from about 30 to about 50 mg/daily intake.

In another example the herb and galactogogue can be turmeric. In one example the supplement can contain from about 10 to about 100 mg/daily intake turmeric, in another example from about 20 to about 80 mg/daily intake, and in another example from about 30 to about 50 mg/daily intake.

In one example, at least a portion of the turmeric can be a supercritical extract (SCE). In one example the supplement can contain at least about 3 mg turmeric SCE, in another example at least about 5 mg, and in another example at least about 7 mg. In another example the composition can contain both whole-food cultured turmeric and turmeric SCE. In one example the ratio of turmeric SCE per daily intake to whole-food cultured turmeric per daily intake can be from about 1:10 to about 1:1, in another example from about 1:8 to about 1:2, in another example from about 1:6 to about 1:2.5, and in another example from about 1:5 to about 1:3.

The supplement can also contain flow agents. Non-limiting examples of flow agents can include gum acacia, silica, lac resin, carnauba wax, maltodextrin, and combinations thereof. In one example the gum acacia can be organic.

In one example, the supplement can be a multivitamin. In one example, the supplement can be administered as the only dietary supplement. In another example, the supplement can be administered with additional dietary supplements, such as fish oil, in particular fish oil from Wild Alaskan Salmon.

In one example, the supplement can weigh from about 500 to about 3300 mg, in another example from about 600 to about 2200 mg, in another example from about 750 to about 1500 mg, and in another example from about 900 to about 1500 mg, and in another example from about 1000 to about 1100 mg.

In one example, the supplement can be taken once daily. In another example, the supplement can be taken twice daily, in another example the supplement can be taken three times daily, in another example the supplement can be taken four times daily, and in another example the supplement can be taken more than four times daily. In one example, the supplement can be taken with meals. In one example, it is recommended that the supplement is taken with meals but it does not have to be taken with meals to avoid an upset stomach. In one example, the supplement can be taken in the morning, mid-day, afternoon, evening, and/or night. In one example, the supplement can be taken at the same time every day. In another example, the time the supplement is taken can vary. In one example a user administers one supplement every time she takes a supplement, in another example two supplements, in another example three supplements, in another example four supplements, and in another example more than four supplements.

In one example, the daily intake can be contained in one supplement that can be consumed once daily. In another example the daily intake can be split across more than one supplement that can be taken either together or in another example the supplements can be taken throughout the day. In another example, the daily intake can be contained in two supplements and a user can administer two supplements once daily or one supplement can be administered twice daily. In another example, the daily intake can be contained in three supplements and a user can administer three supplements once daily or administer one supplement three times daily. In another example, the daily intake can be contained in four or more supplements that can be administered one to four times daily.

In another example, the daily intake can be contained in more than one supplement. The supplements can be the same, where each supplement has a portion of the daily intake and in another example, at least one supplement can be different.

In one example, the user is a normal lactating woman. In one example, the vitamin supports healthy breast milk production. In another example, the supplement is not meant to be administered to women who are having trouble producing enough breast milk. In another example, the supplement is not meant to be administered to women who are producing too much breast milk.

In one example, the supplement can be administered to a woman who is breastfeeding and has been identified as having certain nutritional needs. In another example, the supplement can provide energy or help energize a breastfeeding woman. In another example, the supplement can provide lactation support for a breastfeeding woman. In another example, the supplement can provide nutrition for a breastfeeding woman or it can help supplement their nutrition. In another example the supplement can help the mood of a breastfeeding woman. In another example the supplement can help with the unique nutritional needs of a breastfeeding woman. In another example the supplement can help support breast milk production.

In another example, the supplement can be administered for up to about six weeks after the birth of a child, in another example the supplement can be taken for up to about six months after the birth of a child, and in another example the supplement can be administered for up to a year after the birth of a child. In another example the supplement can be administered for the entire time the mother is breastfeeding and/or weaning.

In one example, the supplement can be gluten free. In another example, the supplement can be vegetarian.

In one example, at least one of the components of the vitamins is a super critical extract.

In one example, the supplement does not contain caffeine. In another example, the supplement does not contain soy. In another example, the supplement does not contain peppermint, menthol, spearmint, and/or parsley. In another example, the supplement does not contain shatavari (Asparagus racemosus), raspberry leaf, moringa, fenugreek, oat straw, marshmallow, hops, fennel, garlic, and/or chlorella.

In an example, it can be desirable to avoid adding too many galactogogues because breastfeeding women want balanced breast milk production and adding too many galactogogues can cause too much breast milk. However, it can be desirable to have some galactogogues in order to help breastfeeding women have sufficient milk supply.

In one example, the supplement does not contain docosahexaenoic acid (DHA). In another example, the supplement can contain DHA. In one example, the supplement can contain from about 25 mg to about 500 mg DHA, in another example from about 50 mg to about 400 mg, in another example from about 100 mg to about 300 mg, and in another example from about 150 mg to about 250 mg DHA.

In another example, the supplement does not contain eicosapentaenoic acid (EPA). In another example, the supplement can contain EPA. In one example, the supplement can contain from about 50 mg to about 500 mg EPA, in another example from about 100 mg to about 400 mg, in another example from about 150 mg to about 350 mg, and in another example from about 200 mg to about 300 mg DHA.

In one example, the supplement is a tablet and the tablet is not coated. In another example, the supplement does not contain gelatin.

### EXAMPLE

| Ingredient | Daily Intake | |
|---|---|---|
| Active Ingredients | | |
| Vitamin C (granulated)^{†} | 45 | mg |
| Vitamin D^{†} | 2000 | IU |
| Vitamin E (Acetate)^{†} | 36 | IU |
| Vitamin K1^{†} | 70 | μg |
| Vitamin K2 | 10 | μg |
| Vitamin B1^{†} | 4 | mg |
| Vitamin B2† | 5 | mg |
| Vitamin B3 (Niacinamide)^{†} | 20 | mg |
| Vitamin B6 (Pyridoxin)^{†} | 10 | mg |
| Folic Acid^{†} | 40 | μg |
| Vitamin B12 (Cobalamin)^{†} | 40 | μg |
| Vitamin B7 (Biotin)^{†} | 300 | μg |
| Pantothenic Acid^{†} | 10 | mg |
| Lithothamnion calcareum powder - | | |
| 75 mg calcium and 5 mg magnesium | | |
| Magnesium^{†} | 20 | mg |
| Iron^{†} | 9 | mg |
| Iodide^{†} | 75 | μg |
| Zinc^{†} | 10 | mg |
| Selenium^{†} | 70 | μg |
| Copper^{†} | 1000 | μg |
| Manganese^{†} | 2 | mg |
| GTF (glucose tolerance factor) | 100 | μg |
| Chromium^{†} | | |
| Molybdenum^{†} | 20 | μg |
| Beta-carotene^{†} | 5000 | IU |
| Fermented Herbal Blend | 331.25 | mg |
| Organic Oat* | | |
| Organic Lemon Balm Leaf* | | |
| Organic Chamomile Flower* | | |
| Organic Lavender Flower* | | |
| Organic Cardamom seed* | | |
| Full-Spectrum Herbs and Extracts | | |
| Organic Kelp powder - 75 μg | 120 | mg |
| iodine | | |
| Organic Amla AQ Extract - 45 mg | 90 | mg |
| vitamin C | | |
| Organic Black Cumin Seed | 40 | mg |
| Organic Turmeric^{†} | 32 | mg |
| Organic Turmeric SCE | 8 | mg |
| Non-Active Ingredients | | |
| Organic Gum Acacia | | |
| Silica | | |

^{†}Indicates active ingredient that was produced using a dual stage probiotic fermentation process
*Indicates fermented herbal
The supplement in the above example was made using general tableting techniques.

While the specification concludes with the claims particularly pointing and distinctly claiming the invention, it is believed that embodiments of the present invention will be better understood from this description. In all embodiments of the present invention, all weight percentages are by weight of the total composition, unless specifically stated otherwise. All ratios are weight ratios, unless specifically stated otherwise. All ranges are inclusive and combinable. The number of significant digits conveys neither limitation on the indicated amounts nor on the accuracy of the measurements. All measurements are understood to be made at 25° C. and at ambient conditions, where “ambient conditions” means conditions under about one atmosphere of pressure and at about 50% relative humidity. All such weights as they pertain to listed ingredients are based on the active level and do not include carriers or by-products that may be included in commercially available materials, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A daily intake formulated for breastfeeding women comprising:
a. less than about 18 mg per daily intake iron;
b. greater than about 2 mg per daily intake vitamin B6;
c. iodine;
d. greater than about 600 IU per daily intake vitamin D; and
e. herbs and galactogogues wherein the herbs and galactogogues support milk production.

2. The daily intake of claim 1 wherein the vitamin D is vitamin D3.

3. The daily intake of claim 1 wherein at least a portion of the iodine is from kelp.

4. The daily intake of claim 1 wherein the herbs and galactogogues are selected from the group consisting of oat, lemon balm leaf, chamomile flower, lavender flower, cardamom seed, and combinations thereof.

5. The daily intake of claim 4 wherein the herbs and galactogogues are fermented.

6. The daily intake of claim 1 wherein the herbs and galactogogues are selected from the group consisting of kelp, amla, cumin seed, turmeric, and combinations thereof.

7. The daily intake of claim 1 further comprising vitamin B 1, vitamin B2, vitamin B3, vitamin B5, vitamin B7, and vitamin B9.

8. The daily intake of claim 1 further comprising from about 60 mg to about 120 mg vitamin C.

9. The daily intake of claim 1 further comprising calcium wherein at least a portion of the calcium is from Lithothamnion calcareum.

10. The daily intake of claim 1 further comprising greater than about 10 mg magnesium and wherein at least a portion of the magnesium is from Lithothamnion calcareum.

11. The daily intake of claim 1 further comprising from about 1 to about 3 mg manganese.

12. A method of supporting the overall health and well-being of a breastfeeding woman by administering the composition of claim 1.

13. A method of supporting the mood of a breastfeeding woman by administering the composition of claim 1.

14. A method of supporting the digestion of a breastfeeding woman by administering the composition of claim 1.

15. A method of supporting the lactation of a breastfeeding woman by administering the composition of claim 1.

16. A method of supporting the digestion of a breastfeeding woman by administering the composition of claim 1.

17. A daily intake formulated for breastfeeding women comprising:
a. less than about 18 mg per daily intake iron;
b. greater than about 2 mg per daily intake vitamin B6;
c. iodine wherein at least a portion of the iodine is from kelp;
d. greater than about 600 IU per daily intake vitamin D3;
e. a first herbs and galactogogues selected from the group consisting of oat, lemon balm leaf, chamomile flower, lavender flower, cardamom seed, and combinations thereof and wherein the first herbs and galactogogues are fermented;
f. a second herbs and galactogogues selected from the group consisting of kelp, amla, cumin seed, turmeric, and combinations thereof;
g. from about 60 mg to about 120 mg vitamin C;
h. from about 50 mg to about 150 mg calcium;
i. greater than about 10 mg magnesium;
j. from about 1 to about 3 mg manganese;
wherein the daily intake supports the overall health and well-being of a breastfeeding woman.

18. A method of supporting the overall health and well-being of a breastfeeding woman by administering a daily intake comprising:
a. less than about 18 mg per daily intake iron;
b. greater than about 2 mg per daily intake vitamin B6;
c. iodine wherein at least a portion of the iodine is from kelp;
d. greater than about 600 IU per daily intake vitamin D3; and
e. herbs and galactogogues wherein the herbs and galactogogues support milk production;
wherein the composition is gentle enough that it can be administered on an empty stomach; and
wherein the daily intake comprises one or more tablets.

19. The method of claim 18 wherein the daily intake comprises at least two tablets and the tablets are administered at least twice daily.

20. The method of claim 19 wherein each tablet weighs from about 750 mg to about 1500 mg.
